(19) United States
(12) Patent Application Publication
(10) Pub. No.: US 2009/0015157 A1
(43) Pub. Date: Jan. 15, 2009

(54) PHOSPHOR PACKAGE OF LIGHT EMITTING DIODES

(76) Inventors: Ching-Cherng Sun, Jhongli City (TW); Shih-Hsin Ma, Jhongli City (TW); Tsung-Xian Lee, Jhongli City (TW)

Correspondence Address: HDSL, P.O. BOX 220746, CHANTILLY, VA, 20153-0746, US

(21) Appl. No.: 11/839,132

(22) Filed: Aug. 15, 2007

(30) Foreign Application Priority Data
Jul. 10, 2007 (TW) 096125065

(51) Int. Cl. H01J 63/04

(52) U.S. Cl. 313/512

(57) ABSTRACT

A phosphor package of light emitting diodes includes a lens made of a transparent optical material, and a side of the lens with at least one phosphor containing groove corresponding to a light emitting diode chip. The concentration of the phosphor is adjusted before a required quantity of phosphor is adhered into the phosphor containing groove. The phosphor is baked and solidified. A gel is filled into the gap between the wire-bonded light emitting chip and the phosphor for binding with each other to complete the manufacturing process of a phosphor package; and such manufacturing process can effectively and accurately control the phosphor to achieve high quality stability and color uniformity.

### FIELD OF THE INVENTION

The present invention relates to a phosphor package of light emitting diodes, and more particularly to a modification of technology and manufacturing process of a phosphor package of light emitting diodes without increasing cost, and the invention overcomes the shortcomings of the prior art being incapable of accurately controlling phosphor cubes of a phosphor powder and causing quality stability and color uniformity issues.

### BACKGROUND OF THE INVENTION

In 1996, Nichia Corporation developed a blue-light InGaN light emitting diode (LED) chip together with a yellow-light Ce-doped yttrium aluminum garnet (YAG:Ce) phosphor powder using cerium as a light emitting activator to form a white-light light source and unveiled the white-light LED market. White-light LED has the advantages on energy saving and environmental protection over traditional light sources and complies with the global development trend of green lights. Therefore, it is a goal for researches and manufacturers to enhance the quality stability and the color uniformity of LED.

Phosphor powder plays an important role to the white-light LED, and thus the white-light performance determines the concentration and uniformity of phosphor powder, and the coating position, shape, concentration and uniformity of the phosphor powder have a significant effect on the quality of a white-light LED (including light extraction efficiency, color temperature and color uniformity, etc.)

Present phosphor powder packaging technologies generally coat or glue phosphor powder onto an LED chip, but such arrangement usually cannot accurately control the position, shape, size, concentration, uniformity and thickness of phosphor cubes of the phosphor powder, and thus causes quality stability and color uniformity issues in the manufacturing process. Obviously, the invention can improve over the prior art and enhance the competitiveness of similar products in the industry.

### SUMMARY OF THE INVENTION

In view of the foregoing shortcomings of the prior art phosphor powder packaging technology being incapable of accurately controlling the coating or gluing of phosphor cubes of a phosphor powder onto an LED chip and causing unstable quality and poor color uniformity, the inventor of the present invention based on years of experience in the related field to conduct extensive researches and experiments, and finally developed a phosphor package of light emitting diodes in accordance with the present invention.

It is a primary objective of the present invention to provide a phosphor package of light emitting diodes, wherein the package process produces a lens made of a transparent optical material, and a surface of the lens includes at least one phosphor powder containing groove corresponding to an LED chip, and then prepares a phosphor powder with an appropriate concentration and attaches a required quantity of the phosphor powder directly into the phosphor powder containing groove. The present invention has the following advantages:

1. The position and shape of the phosphor powder can be changed freely to achieve a light source of an LED chip 30, 50 with high efficiency and high color uniformity.

2. The parameters including the size, concentration, uniformity and thickness of phosphor powder can be controlled accurately to achieve a light source of an LED chip 30, 50 with high efficiency, constant color temperature and stable manufacture.

3. The phosphor powder lens made of a transparent optical material can stand a high-temperature manufacturing process.

4. The phosphor powder and the phosphor powder lens are integrated as a whole, so that the package process can be simplified.

5. The package process of the invention can meet the requirements for diversified designs and high-temperature process.

6. The package process of the invention can be applied to the package and illumination industries of the LED chip.

### BRIEF DESCRIPTION OF THE DRAWING

FIG. 1 is a flow chart of a phosphor powder package process in accordance with the present invention;

FIG. 2 is a side sectional view of a phosphor powder lens produced by a phosphor powder package process in accordance with the present invention;

FIG. 3 is a top view of FIG. 2; and

FIG. 4 is a side sectional view of another phosphor powder lens produced by a phosphor powder packaging process in accordance with the present invention.

### DETAILED DESCRIPTION OF THE PREFERRED EMBODIMENTS

To make it easier for our examiner to understand the objective of the invention, its structure, innovative features, and performance, we use preferred embodiments together with the attached drawings for the detailed description of the invention.

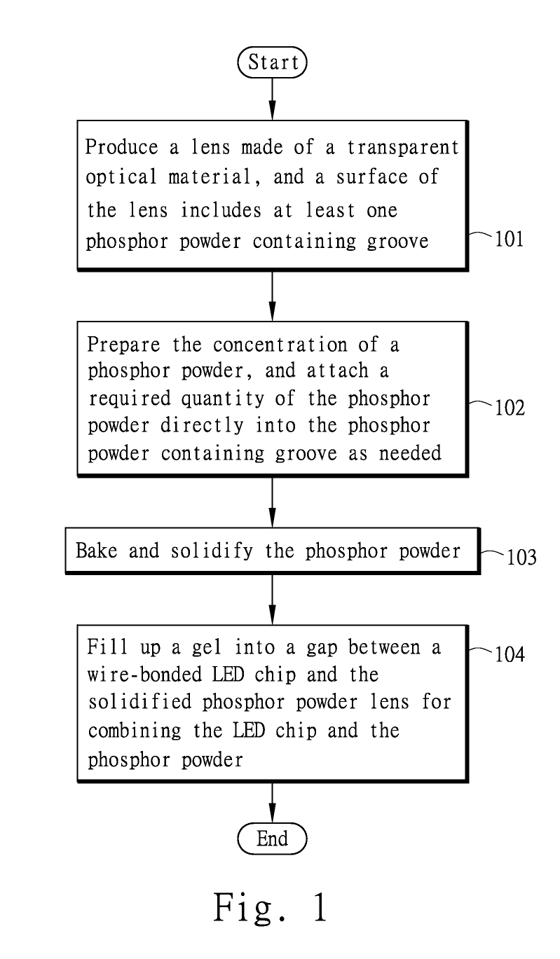

The present invention provides a phosphor package of light emitting diodes. Since the coating position, shape, concentration and uniformity of the phosphor powder have significant effects on the quality of a white-light LED (including light extraction efficiency, color temperature and color uniformity, etc), the invention provides a manufacturing process for a phosphor package of light emitting diodes that can accurately control the parameters including the position, shape, size, concentration, uniformity and thickness of phosphor powder during the package process of the light emitting diodes. Referring to FIG. 1, the processing procedure comprises the following steps:

Step (101): A lens made of a transparent optical material (such as glass, silicon gel or resin) is used, and a surface of the lens includes at least one phosphor powder containing groove (whose size and shape can be changed according to actual needs; for example, the shape can be a horizontal shape, a wavy shape, an arc shape or an irregular shape) corresponding to an LED chip.

Step (102): The concentration of a phosphor powder is prepared, and a required quantity of the phosphor powder (which can vary or come with an inconsistent or unequal thickness) is attached directly into the phosphor powder containing groove (by titration, coating or gluing.)

Step (103): The phosphor powder is baked and solidified.

Step (104): A gel is filled up into a gap between a wire-bonded LED chip and the solidified phosphor powder lens for combining the LED chip and the phosphor powder, so as to complete the manufacturing process of a phosphor package of light emitting diodes in accordance with the present invention.

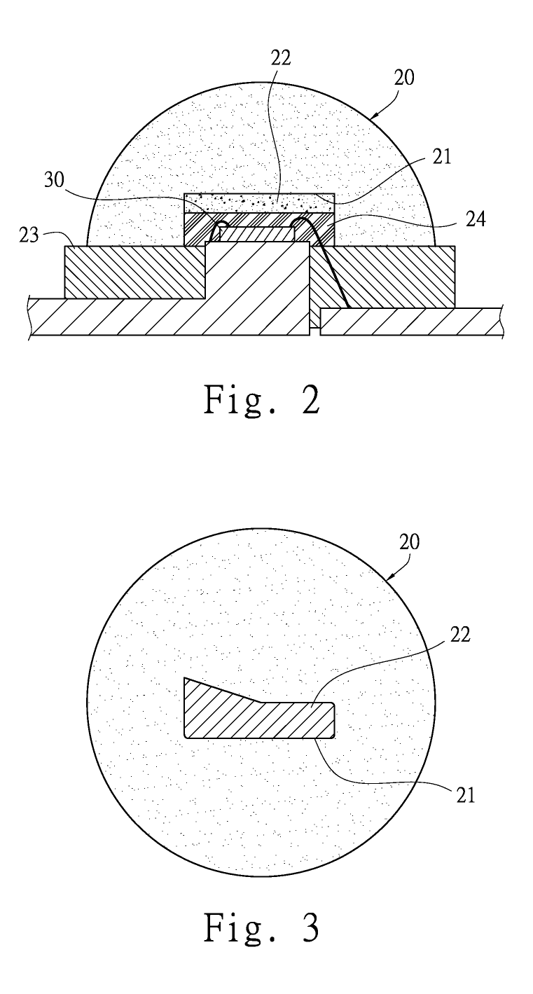

Referring to FIGS. 2 and 3 for a side sectional view and a top view of a phosphor powder lens produced by the phosphor powder package process respectively, a surface of the phosphor powder lens 20 includes at least one phosphor powder containing groove 21 corresponding to the LED chip 30, whose size and shape can be changed according to the actual needs. In this preferred embodiment, the phosphor powder containing groove 21 is in a horizontal irregular shape, and the required quantity of phosphor powder 22 for the direct attachment can be of different variable levels, or an inconsistent or unequal thickness. After the phosphor powder is baked and solidified, a gel 24 is filled up into a gap between a wire-bonded LED chip 30 on a support frame 23 and the phosphor powder lens 20 for combining the LED chip 30 and the phosphor powder lens 20.

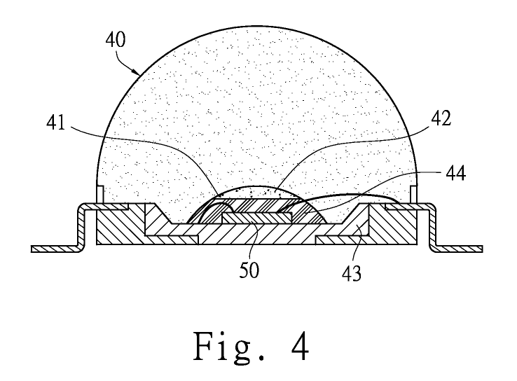

Referring to FIG. 4 for a side sectional view of another phosphor powder lens produced by a phosphor powder package process in accordance with the present invention, a surface of the phosphor powder lens 40 includes at least one phosphor powder containing groove 41 corresponding to an LED chip 50, and the size and shape of the phosphor powder containing groove 41 can be changed according to actual needs. In this preferred embodiment, the phosphor powder containing groove 41 is in an arc shape, and a required quantity of phosphor powder 42 is attached into the phosphor powder containing groove 41, and the required quantity of phosphor powder 42 can be of different variable levels, or an inconsistent or unequal thickness. After the phosphor powder is baked and solidified, a gel 44 is filled up into a gap between a wire-bonded LED chip 50 on a support frame 43 and the phosphor powder lens 40 for combining the LED chip 50 and the phosphor powder lens 40.

The external surface of the phosphor powder containing groove 41 of the aforementioned phosphor powder lens 20, 40 can be changed into a different shape according to the structure of the support frame 23, 43.

Therefore, the improvements of the package process of the present invention made over the prior art reside on:

1. The position and shape of the phosphor powder 22, 42 of the invention can be changed freely to achieve a light source of an LED chip 30, 50 with high efficiency and high color uniformity.

2. The invention can accurately control the parameters including the size, concentration, uniformity and thickness of the phosphor powder 22, 42 to achieve a light source of an LED chip 30, 50 with high efficiency, constant color temperature and stable manufacture.

3. The phosphor powder lens 20, 40 made of a transparent optical material can stand a high-temperature manufacturing process.

4. The phosphor powder 22, 42 and the phosphor powder lens 20, 40 are integrated as a whole, and thus the package process can be simplified.

5. The package process of the invention can meet the requirements for diversified designs and high-temperature process.

6. The package process of the invention can be applied to the package and illumination industries of the LED chip 30, 50.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A phosphor package of light emitting diodes (LEDs), comprising the steps of:
producing a lens made of a transparent optical material, such that a surface of the lens includes at least one phosphor powder containing groove corresponding to a LED chip;
preparing the concentration of a phosphor powder, and attaching the phosphor powder directly into the phosphor powder containing groove according to a predetermined quantity;
baking and solidifying the phosphor powder; and
filling up a gel into a gap between a wire-bonded LED chip and the solidified phosphor powder lens to combine the LED chip and the phosphor powder lens, so as to complete the phosphor powder package process.

2. The phosphor package of light emitting diodes as recited in claim 1, wherein the lens is made of glass, silicon gel or resin.

3. The phosphor package of light emitting diodes as recited in claim 1, wherein at least one phosphor powder containing groove is in a horizontal shape, a wavy shape, an arc shape or an irregular shape.

4. The phosphor package of light emitting diodes as recited in claim 1, wherein the phosphor powder comes with a required quantity of different variable levels, or an inconsistent or unequal thickness.

5. The phosphor package of light emitting diodes as recited in claim 1, wherein the attachment is achieved by titration, coating or gluing.

6. The phosphor package of light emitting diodes as recited in claim 3, wherein at least one phosphor powder containing groove has an external surface in a shape that varies according to a support structure for fixing the LED chip.
